(19) United States
(12) Patent Application Publication
(10) Pub. No.: US 2014/0225962 A1
(43) Pub. Date: Aug. 14, 2014

(54) POLING METHOD, POLING DEVICE FOR PIEZOELECTRIC ELEMENT AND INKJET PRINT HEAD

(71) Applicant: SAMSUNG ELECTRO-MECHANICS CO., LTD., Suwon (KR)

(72) Inventors: Tae Kyung LEE, Suwon (KR); Jae Chang Lee, Suwon (KR); Hwa Sun Lee, Suwon (KR)

(73) Assignee: Samsung Electro-Mechanics Co., LTD., Suwon (KR)

(21) Appl. No.: 13/859,989

(22) Filed: Apr. 10, 2013

(30) Foreign Application Priority Data
Feb. 14, 2013 (KR) 10-2013-0015793

(51) Int. Cl. B41J 2/14

(52) U.S. Cl. CPC B41J 2/14201
USPC 347/68

(57) ABSTRACT

There is provided a poling method for a piezoelectric element, including performing preliminary poling of the piezoelectric element twice or more with different voltages and measuring conductance of the piezoelectric element with regard to respective voltage, establishing a relational expression between the voltage and the conductance of the piezoelectric element, calculating targeted conductance required to exhibit a targeted piezoelectric characteristic of the piezoelectric element, and selecting a targeted voltage level corresponding to the targeted conductance and performing final poling of the piezoelectric element at the targeted voltage level.

### CROSS-REFERENCE TO RELATED APPLICATION

This application claims the priority of Korean Patent Application No. 10-2013-0015793 filed on Feb. 14, 2013, in the Korean Intellectual Property Office, the disclosure of which is incorporated herein by reference.

### BACKGROUND OF THE INVENTION

1. Field of the Invention

The present invention relates to a piezoelectric element, and more particularly, to a poling method and a poling device for a piezoelectric element capable of improving poling reliability of a piezoelectric element and shortening a required poling time, as well as to an inkjet print head.

2. Description of the Related Art

A piezoelectric element has been widely used as a driving unit for inkjet print heads, micro pumps, micro fluid discharge devices and various other small devices. Piezoelectric elements generate a predetermined degree of physical displacement through current supplied thereto through an electrode, to provide required driving force to respective device.

Generally, displacement of the piezoelectric element varies according to a poling condition thereof. For example, the displacement of a piezoelectric element may vary according to a magnitude of poling voltage and/or the time of the application of poling voltage, or the like. Therefore, the displacement of the piezoelectric element may be arbitrarily adjusted by adjusting the poling conditions according to the type of device using the piezoelectric element.

However, even though the displacement of the piezoelectric element may be performed under the same poling conditions, the displacement of the piezoelectric element may vary according to piezoelectric characteristics of the piezoelectric element, the manufacturing environment of the piezoelectric element, and the manufacturer of the piezoelectric element. Thus, a plurality of piezoelectric elements poled under the same conditions may have different degrees of displacement, thereby reducing the reliability of devices that use a plurality of piezoelectric elements as actuators (for example, an inkjet print head).

As related art aimed at solving the above-described problem, there is provided the following related art document, disclosing technology for measuring displacement of a piezoelectric element measured in a plurality of poling processes to calculate a final poling voltage.

However, the displacement of the piezoelectric element is changed for each portion of the piezoelectric element and the correlation between the obtained displacement and the poling voltage does not necessarily have a proportional relationship, such that it may be difficult to obtain a reliable final poling voltage.

Further, it takes a significant amount of time to obtain the final poling voltage disclosed in the following related art document, such that it may be difficult to pole the plurality of piezoelectric elements simultaneously.

### RELATED ART DOCUMENT

KR 2009-0005631A

### SUMMARY OF THE INVENTION

An aspect of the present invention provides a poling method and a poling device for a piezoelectric element, capable of improving poling reliability of a piezoelectric element and shortening a required poling time, as well as an inkjet print head.

According to an aspect of the present invention, there is provided a poling method for a piezoelectric element, including: performing preliminary poling of the piezoelectric element twice or more with different voltages and measuring conductance of the piezoelectric element with regard to respective voltage; establishing a relational expression between the voltage and the conductance of the piezoelectric element; calculating targeted conductance required to exhibit a targeted piezoelectric characteristic of the piezoelectric element; and selecting a targeted voltage level corresponding to the targeted conductance and performing final poling of the piezoelectric element at the targeted voltage level.

The performing of the preliminary poling may include: performing first preliminary poling of the piezoelectric element at a first voltage level and measuring a first conductance of the piezoelectric element for the first voltage level; and performing second preliminary poling of the piezoelectric element at a second voltage level and measuring a second conductance of the piezoelectric element for the second voltage level.

The second voltage level may be higher than the first voltage level.

The voltage performing the preliminary poling may be set to be lower than the targeted voltage level.

The piezoelectric element may be a plurality of actuators mounted in an inkjet print head.

The targeted piezoelectric characteristic may indicate a discharge speed of ink.

According to an aspect of the present invention, there is provided a poling device for a piezoelectric element, including: a plurality of voltage generation units generating different magnitudes of voltage for poling a plurality of piezoelectric elements; a plurality of conductance measurement units measuring conductance of the piezoelectric element; and a control unit storing voltage generated by the voltage generation unit and conductance measured by the conductance measurement unit, respectively, and setting target voltages for performing final poling of the plurality of piezoelectric elements, based on a relational expression between the stored voltage and the conductance of the piezoelectric element, respectively.

The control unit may individually set final poling voltages for the plurality of piezoelectric elements.

The control unit may set the final poling voltages for the plurality of piezoelectric elements simultaneously.

According to an aspect of the present invention, there is provided an inkjet print head, including: a plurality of piezoelectric elements for providing driving force to a plurality of pressure chambers, wherein uniformity (% range) of the plurality of piezoelectric elements is 30% or less.

The uniformity (% range) may be represented by a percentage (%) after dividing a difference between a maximum displacement and a minimum displacement of the piezoelectric element by an average displacement.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional perspective view of an inkjet print head;

FIG. 2 is a configuration diagram of a poling device for a piezoelectric element according to an embodiment of the present invention;

FIG. 3 is a flow chart of a poling method for a piezoelectric element according to an embodiment of the present invention;

FIG. 4 is a diagram illustrating a relationship between conductance and voltage;

FIG. 5 is a diagram illustrating a relationship between conductance and displacement of a piezoelectric element;

FIG. 6 is a diagram illustrating a relationship between conductance and ink discharge speed; and

FIG. 7 is a flow chart of a poling method for a piezoelectric element according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Performance of a device in which a plurality of piezoelectric elements are provided may depend on piezoelectric characteristics of the piezoelectric elements. For example, quality of discharged ink discharged from an inkjet print head may depend on the piezoelectric characteristics of the piezoelectric element. In particular, the piezoelectric element may have different piezoelectric characteristics according to a manufacturing environment thereof, such that it may be difficult to realize uniform discharge characteristics in all nozzles provided in the inkjet print head.

Embodiments of the present invention may be provided to solve this problem, and may perform the poling of the piezoelectric element in the state in which the piezoelectric element is mounted in the inkjet print head to realize uniform discharge characteristics in the inkjet print head.

Further, according to the embodiment of the present invention, the poling of the piezoelectric element using electrical characteristics (impedance or conductance) of the piezoelectric element may be performed, thereby rapidly performing poling of the piezoelectric element.

Hereinafter, embodiments of the present invention will be described in detail with reference to the accompanying drawings.

In describing the present invention below, terms indicating components of the present invention will be named in consideration of functions thereof. Therefore, the terms should not be understood as limiting the technical components of the present invention.

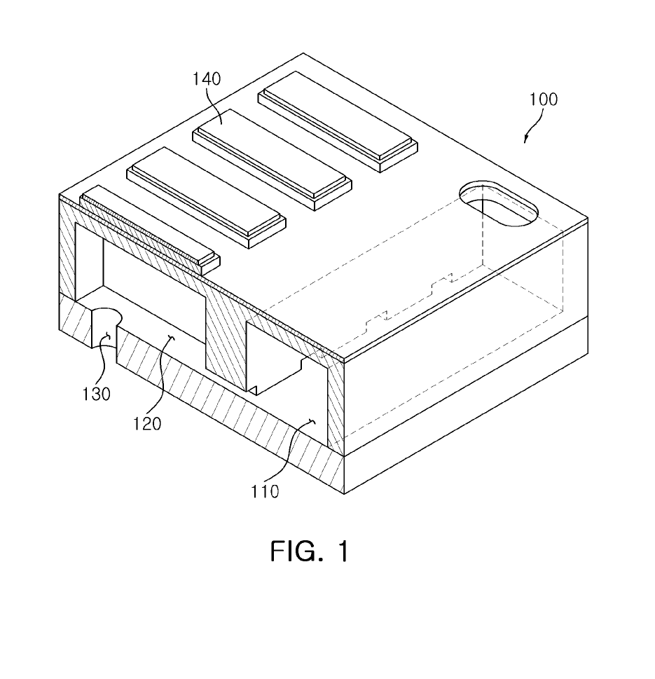

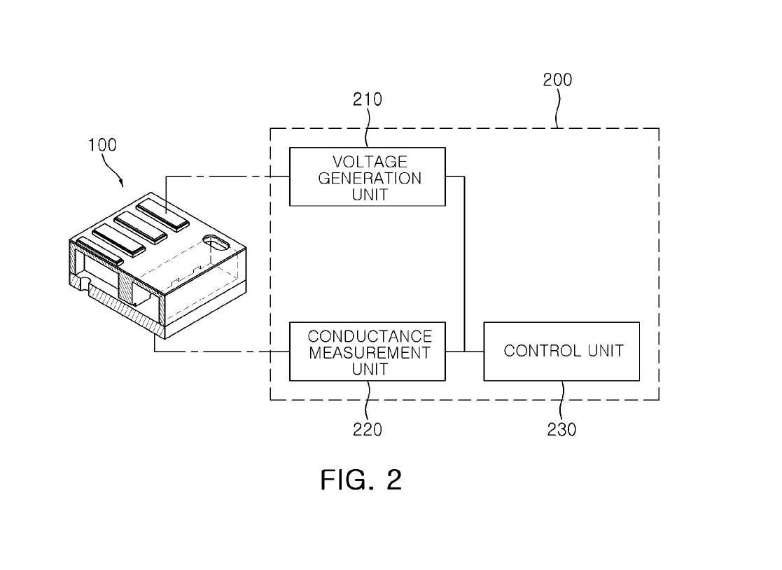

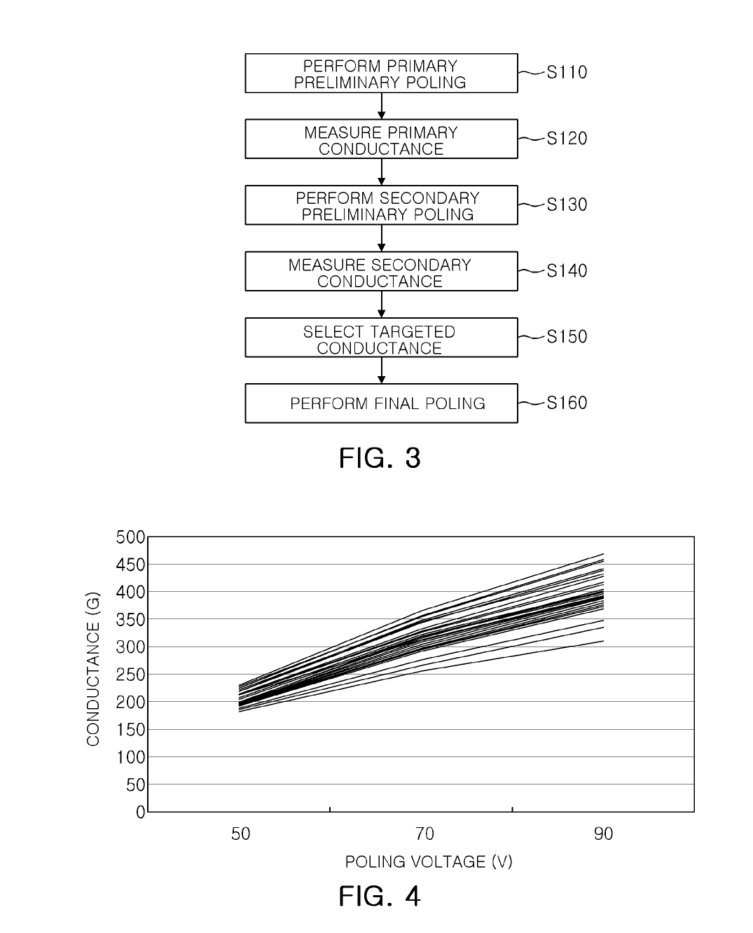

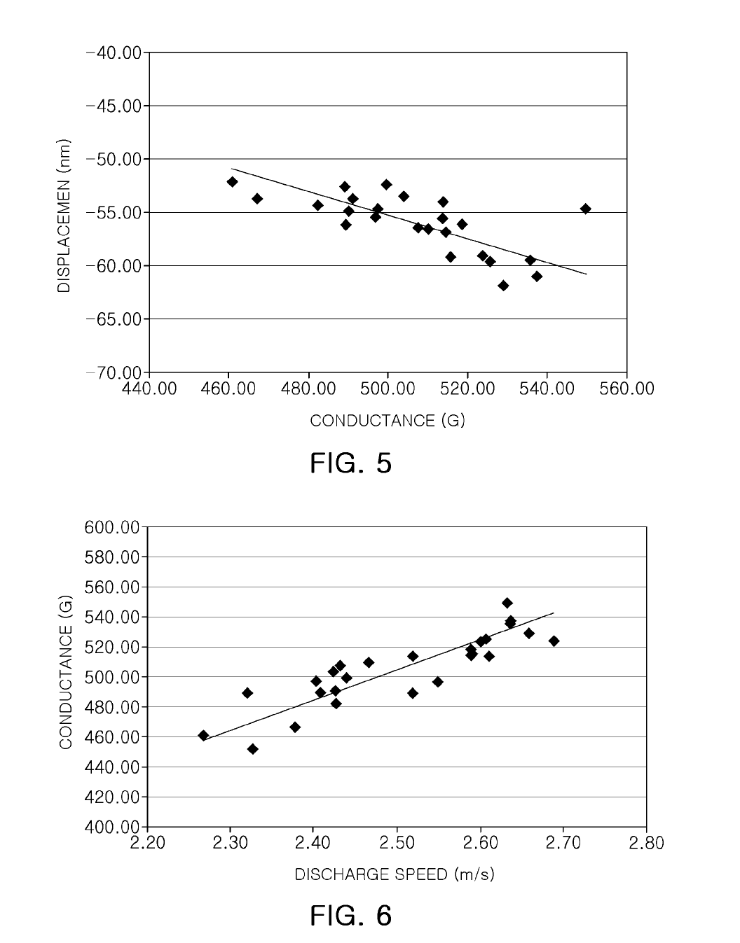

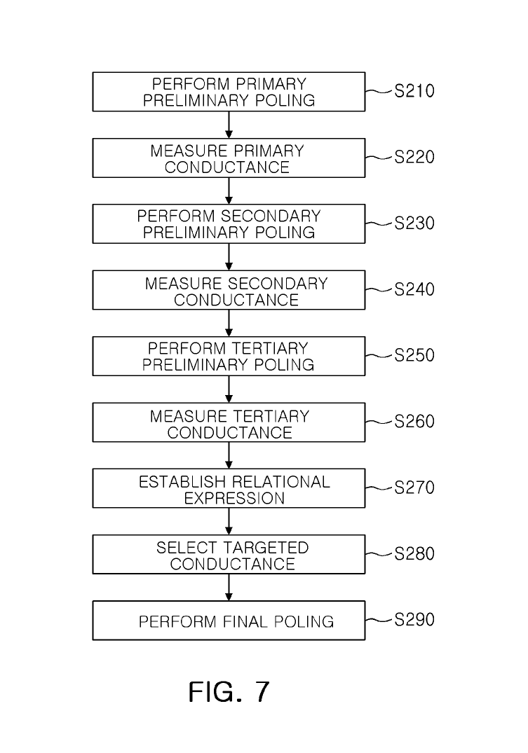

FIG. 1 is a cross-sectional perspective view of an inkjet print head, FIG. 2 is a configuration diagram of a poling device for a piezoelectric element according to an embodiment of the present invention, FIG. 3 is a flow chart of a poling method for a piezoelectric element according to an embodiment of the present invention, FIG. 4 is a diagram illustrating a relationship between conductance and voltage, FIG. 5 is a diagram illustrating a relationship between conductance and displacement of a piezoelectric element, FIG. 6 is a diagram illustrating a relationship between conductance and ink discharge speed, and FIG. 7 is a flow chart of a poling method for a piezoelectric element according to another embodiment of the present invention.

A structure of the inkjet print head in which a plurality of piezoelectric elements are mounted will be briefly described with reference to FIG. 1. For reference, it is to be noted that “actuator” is used herein as a term having the same meaning as “piezoelectric element” and these components may be denoted by the same reference numeral 140.

An inkjet print head 100 may include a manifold 110, a pressure chamber 120, a nozzle 130, and an actuator 140. Herein, the manifold 110 may supply ink to a plurality of pressure chambers 120 and the pressure chamber 120 may store an amount of ink required for a single discharge. In addition, the actuator 140 may provide driving force required to discharge the ink in the pressure chamber 120 through the nozzle 130.

The plurality of pressure chambers 120 may have the same size so as to discharge the same amount of ink. Similarly, each actuator 140 includes a piezoelectric element having the same piezoelectric characteristics so as to provide the same magnitude of driving force to the pressure chamber 120.

However, as described above, the piezoelectric element configuring the actuator 140 may have different piezoelectric characteristics in response to the manufacturing environment thereof. For this reason, even in the case that the actuator 140 is driven by the same electrical signal, the amount of ink discharged through a respective nozzle 130 may be different.

In the embodiment of the invention to solve the problem, the poling of the piezoelectric element may be performed in the state in which the piezoelectric element is mounted in the inkjet print head 100. In this case, poling conditions (that is, poling voltage) of the piezoelectric element may be adjusted by being compared with discharge characteristics (for example, an amount of discharged ink or an ink discharge speed) of the nozzle 130.

However, the discharge characteristics of the nozzle cannot actually be measured, and therefore a final poling voltage of the piezoelectric element may be determined by measuring other characteristics of the piezoelectric element. For example, the final poling voltage of the piezoelectric element may be adjusted by measuring the displacement of the piezoelectric element.

However, the displacement of the piezoelectric element 140 in the inkjet print head 100 is nonlinearly changed in response to a length direction of the piezoelectric element 140, such that determination of the final poling voltage based on the displacement of the piezoelectric element 140 may deteriorate reduces reliability. Therefore, when the displacement of the piezoelectric element 140 is used to determine the final poling voltage of the piezoelectric element 140, the displacement of the piezoelectric element 140 needs to be measured at multiple points. However, the method requires considerable time, unsuitable for a device such as the inkjet print head in which the plurality of piezoelectric elements 140 are mounted.

Therefore, a poling method and a poling device according to an embodiment of the present invention are provided.

The poling method for a piezoelectric element according to the embodiment of the present invention may use the electrical characteristics (for example, impedance or conductance) of the piezoelectric element to determine the final poling voltage of the piezoelectric element. Herein, the impedance and conductance in the electrical characteristics of the piezoelectric element may easily be measured. Further, the impedance and conductance of the piezoelectric element has a generally linear relationship with the discharge characteristics of the nozzle, which may be relatively very effective in improving the discharge characteristics of the inkjet print head.

Herein, a poling device 200 for a piezoelectric element according to an embodiment of the present invention may include a voltage generation unit 210, a conductance measurement unit 220, and a control unit 230 as illustrated in FIG. 2.

The voltage generation unit 210 is electrically connected to the inkjet print head 100 and may apply a predetermined voltage to the plurality of actuators 140 or piezoelectric elements. In addition, the voltage generation unit 210 may apply the same level of voltage to the plurality of actuators 140 simultaneously, or selectively apply a different level of voltage to respective actuators 140. Herein, the magnitude of voltage applied by the voltage generation unit 210 may be adjusted by the control unit 230.

The conductance measurement unit 220 is electrically connected to the inkjet print head 100 and may measure the conductance of the actuator 140 or the piezoelectric element. The conductance measurement unit 220 may send the measured conductance of the actuator 140 or the measured conductance of the piezoelectric element to the control unit 230. For reference, the embodiment of the present invention is described as including the conductance measurement unit 220 to measure the conductance of the actuator 140 or the piezoelectric element, but an impedance measurement unit for measuring the impedance of the actuator 140 or the piezoelectric element may be used instead of the conductance measurement unit 220.

The control unit 230 may be connected to the voltage generation unit 210 and the conductance measurement unit 220. In addition, the control unit 230 may adjust the level of voltage generated by the voltage generation unit 210 and may store the conductance of the actuator 140 or the piezoelectric element that is sent from the conductance measurement unit 220. In addition, the control unit 230 may establish a relational expression between a magnitude of voltage applied to the piezoelectric element and measured conductance. To this end, the control unit 230 may include a separate operation unit. In addition, the control unit 230 may set the final poling voltage (targeted voltage level described in claims) of the piezoelectric element based on the established relational expression. Herein, the targeted voltage level may be obtained by substituting a conductance value corresponding to a targeted piezoelectric characteristic into the relational expression.

Next, a poling method for a piezoelectric element according to an embodiment of the present invention will be described with reference to FIG. 3.

The poling method for a piezoelectric element according to the embodiment of the present invention may include a primary preliminary poling process, a primary conductance measurement process, a secondary preliminary poling process, a secondary conductance measuring process, a targeted conductance selecting process, and a final poling process.

1) Primary Preliminary Poling Process (S110)

In the present process, a primary voltage may be applied to the plurality of piezoelectric elements 140 mounted in the inkjet print head 100. Herein, the primary voltage may be a voltage significantly lower than the final poling voltage of the piezoelectric element that is known in the art.

Meanwhile, in the present process, the primary voltage may be applied to the plurality of piezoelectric elements 140 simultaneously. However, the primary voltage is not necessarily applied to all of the piezoelectric elements 140. For example, the primary voltage may only be applied to a part of the plurality of piezoelectric elements 140, as a sample. For reference, a frequency of the primary voltage may be 1 kHz .

2) Primary Conductance Measuring Process (S120)

In the present process, the primary conductance of the piezoelectric element 140 may be measured in the state in which the primary voltage is applied. Herein, the primary conductance may be individually measured for respective piezoelectric elements 140. The measured primary conductance may be transmitted to the control unit 230. Meanwhile, the primary conductance transmitted to the control unit 230 may be stored along with the primary voltage.

3) Secondary Preliminary Poling Process (S130)

In the present process, a secondary voltage may be applied to the plurality of piezoelectric elements 140 mounted in the inkjet print head 100. Herein, the secondary voltage may be a voltage higher than the primary voltage. Further, the secondary voltage may have a numerical value approaching the final poling voltage of the piezoelectric element that is known in the art. In this case, the reliability for the final poling voltage obtained by using the relational expression between voltage and conductance may be improved.

In the present process, similar to the primary voltage, the secondary voltage may be applied to the plurality of piezoelectric elements 140 simultaneously. However, the secondary voltage is not necessarily applied to all the piezoelectric elements 140 and the secondary voltage may only be applied to apart of the plurality of piezoelectric elements 140, as a sample . For reference, a frequency of the secondary voltage may be 1 kHz.

4) Secondary Conductance Measuring Process (S140)

In the present process, the secondary inductance of the piezoelectric element 140 may be measured in the state in which the secondary voltage is applied. Herein, the secondary conductance may be individually measured for respective piezoelectric elements 140, similar to the primary conductance. Further, the measured secondary conductance may be transmitted to the control unit 230. The secondary conductance sent to the control unit 230 may be stored along with the secondary voltage . For reference, the measurement frequency of the secondary conductance may be 1 kHz.

5) Targeted Conductance Selecting Process (S150)

In the present process, the relational expression between voltage and conductance is established and the targeted conductance may be selected based on the established relational expression. Herein, the relational expression between voltage and conductance may be established by calculating linearity between voltage, and conductance and separate relational expressions for respective piezoelectric elements may be established.

The targeted conductance may be applied to the selection of the conductance value corresponding to the targeted piezoelectric characteristic of the piezoelectric element. Herein, the selection of the targeted conductance may be performed using the relationship between piezoelectric characteristics and conductance obtained by an experiment (for example, see FIGS. 5 and 6). 6) Final Poling Process (S160)

In the present process, the final poling voltage (or targeted voltage level) of the piezoelectric element is set and the piezoelectric element may be poled with the set targeted voltage level. In addition, the preliminary poling of the piezoelectric element may be performed with the targeted voltage and the conductance of the piezoelectric element may be measured.

Herein, when a deviation between the measured conductance and the targeted conductance is within a range of error, the final poling of the piezoelectric element may be performed with the targeted voltage. Unlike this, when the deviation between the measured conductance and the targeted conductance deviates from the error range, the targeted voltage level may be corrected according to the magnitude of the deviation.

For reference, unlike the preliminary poling, the poling working under the targeted voltage conditions may be performed under the high temperature and high pressure state and may be performed for a longer time than the preliminary poling.

Meanwhile, the correlation between the impedance or conductance of the piezoelectric element and the discharge characteristic of the nozzle can be appreciated with reference to FIGS. 4 to 6, and the correlation has been confirmed through repetitive experimentation.

That is, the conductance of the piezoelectric element is substantially in proportion to the magnitude of the poling voltage as illustrated in FIG. 4. Therefore, the relational expression between the conductance and voltage of the piezoelectric element that is a poling object maybe established and the final poling voltage of the piezoelectric element may be reliably established.

In addition, it can be confirmed that the conductance of the piezoelectric element has a substantially linear relationship with the displacement of the piezoelectric element and the discharge speed of ink as illustrated in FIGS. 5 and 6.

Therefore, when the relational expression between the poling voltage applied to the piezoelectric element and the conductance of the piezoelectric element is clearly established, the displacement characteristic of the piezoelectric element and the discharge characteristic of ink may be set as required.

For reference, Table 1 shows the characteristics of the piezoelectric element poled with the same magnitude of voltage and the discharge characteristics of the inkjet print head in which the corresponding piezoelectric element is mounted.

TABLE 1

| | | | | | Displace- |
|---|---|---|---|---|---|
| Piezoelectric | Volume | Speed | Conductance | Frequency | ment |
| Element NO. | [ [symbol] ] | [m/s] | [ [symbol] ] | [kHz] | [nm] |
| CF0101_01-10 | 38.2 | 2.3 | 460.9 | 695.6 | −52.1 |
| CF0101_01-11 | 39.5 | 2.4 | 490.1 | 687.9 | −54.8 |
| CF0101_03-01 | 41.0 | 2.6 | 515.6 | 685.0 | −59.1 |
| CF0101_03-03 | 39.2 | 2.4 | 466.9 | 691.8 | −53.6 |
| CF0101_03-04 | 39.4 | 2.4 | 482.4 | 690.7 | −54.3 |
| CF0101_03-07 | 42.2 | 2.7 | 524.0 | 691.0 | −59.1 |
| CF0101_03-08 | 41.0 | 2.6 | 518.5 | 695.9 | −56.1 |
| CF0101_03-11 | 41.3 | 2.6 | 513.7 | 693.1 | −55.6 |
| CF0101_03-12 | 41.7 | 2.6 | | 685.2 | −59.1 |
| CF0101_04-02 | 40.0 | 2.4 | 507.7 | 692.3 | −56.4 |
| CF0101_04-03 | 39.3 | 2.4 | 503.8 | 693.8 | −53.4 |
| CF0101_04-05 | 40.2 | 2.5 | 489.2 | 689.0 | −56.1 |
| CF0101_04-07 | 41.8 | 2.6 | 535.7 | 693.1 | −59.4 |
| CF0101_04-09 | 38.1 | 2.3 | 489.2 | 699.5 | −52.6 |
| CF0101_04-11 | 41.0 | 2.6 | 514.4 | 693.0 | −56.7 |
| CF0101_04-12 | 42.0 | 2.7 | 529.1 | 686.6 | −61.8 |
| CF0101_05-01 | 41.5 | 2.6 | 523.7 | 685.7 | −58.9 |
| CF0101_05-02 | 39.9 | 2.5 | 513.9 | 692.1 | −54.0 |
| CF0101_05-03 | 39.2 | 2.4 | 499.5 | 694.9 | −52.4 |
| CF0101_05-06 | 41.3 | 2.6 | 525.6 | 685.9 | −59.6 |
| CF0101_05-10 | 41.3 | 2.6 | 549.6 | 698.3 | −54.6 |
| CF0101_07-02 | 41.2 | 2.5 | 496.8 | 693.1 | −55.3 |
| CF0101_07-03 | 39.1 | 2.4 | 490.9 | 693.9 | −53.8 |
| CF0101_07-04 | 39.1 | 2.4 | 497.2 | 691.6 | −54.6 |
| CF0101_07-07 | 41.8 | 2.6 | 537.6 | 691.3 | −61.0 |
| CF0101_07-08 | 39.9 | 2.5 | 510.1 | 696.7 | −56.6 |

[symbol]

indicates data missing or illegible when filed

As can be appreciated from Table 1, the conductance of the piezoelectric element has a considerable correlation with the volume of discharged ink, the discharge speed of ink, and the displacement of the piezoelectric element. In addition, respective piezoelectric elements exhibit different piezoelectric characteristics under the same voltage conditions.

Next, a poling method for a piezoelectric element according to another embodiment of the present invention will be described with reference to FIG. 7.

The poling method for a piezoelectric element according to the present embodiment may include a primary preliminary poling process (S210), a primary conductance measuring process (S220), a secondary preliminary poling process (S230), a secondary conductance measuring process (S240), a tertiary preliminary poling process (S250), a tertiary conductance measuring process (S260), a relational expression establishing process (S270), a targeted conductance selecting process (S280), and a final poling process (S290).

That is, the poling method for a piezoelectric element according to the present embodiment may be differentiated from the foregoing embodiments in that the preliminary poling process is performed three or more times. In other words, in the poling method for a piezoelectric element according to the present embodiment, the preliminary poling process may be performed three or more times so as to derive the accurate correlation and relational expression between voltage and conductance. In addition, the relational expression between voltage and conductance may be established using a least square method.

In the poling method for a piezoelectric element configured as described above, the plurality of preliminary poling processes may be performed to thus establish the relational expression between voltage and conductance so as to more easily determine the poling voltage through the conductance and more improve the reliability of the determined poling voltage.

Table 2 shows the conductance of the piezoelectric element measured by the poling method for a piezoelectric element according to another embodiment of the present invention. For reference, the frequency of a primary to tertiary poling voltages may be 1 kHz.

TABLE 2

| | | Secondary | | |
|---|---|---|---|---|
| | Primary Poling | Poling | Tertiary Poling | Final |
| Conductance | (50 V Voltage) | (70 V Voltage) | (90 V Voltage) | Poling |
| Average | 204.74 | 317.52 | 407.21 | 472.75 |
| Minimum | 182.27 | 254.38 | 309.75 | 434.15 |
| Maximum | 230.15 | 364.58 | 470.32 | 520.12 |
| Uniformity | 23.39 | 34.71 | 39.43 | 18.19 |
| (% range) | | | | |

(Table 2 shows that uniformity (% range) is represented by a percentage (%) after dividing a difference between a maximum displacement and a minimum displacement of the piezoelectric elements mounted in the inkjet print head by an average displacement)

As can be appreciated from Table 2, in the poling method for a piezoelectric element according to the present embodiment, a final poling voltage may be set to more approximate a value of uniformity with regard to the final poling showing in Table 2 above to improve the uniformity of ink ejection from the inkjet print head.

That is, according to the poling method for a piezoelectric element according to the present embodiment, the piezoelectric characteristics of the piezoelectric elements mounted in the inkjet print head may substantially match each other to improve the discharge quality of the inkjet print head.

As set forth above, according to the embodiments of the present invention, the poling speed of the piezoelectric element may be improved.

Further, according to the embodiment of the present invention, the piezoelectric element having the uniform piezoelectric characteristics may be manufactured. Therefore, according to the embodiment of the present invention, the operational reliability of devices (for example, an inkjet print head) in which the plurality of piezoelectric elements are mounted may be improved.

While the present invention has been shown and described in connection with the embodiments, it will be apparent to those skilled in the art that modifications and variations can be made without departing from the spirit and scope of the invention as defined by the appended claims.

What is claimed is:

1. A poling method for a piezoelectric element, comprising:
performing preliminary poling of the piezoelectric element twice or more with different voltages and measuring conductance of the piezoelectric element with regard to respective voltage;
establishing a relational expression between the voltage and the conductance of the piezoelectric element;
calculating targeted conductance required to exhibit a targeted piezoelectric characteristic of the piezoelectric element; and
selecting a targeted voltage level corresponding to the targeted conductance and performing final poling of the piezoelectric element at the targeted voltage level.

2. The poling method of claim 1, wherein the performing of the preliminary poling includes:
performing first preliminary poling of the piezoelectric element at a first voltage level and measuring a first conductance of the piezoelectric element for the first voltage level; and
performing second preliminary poling of the piezoelectric element at a second voltage level and measuring a second conductance of the piezoelectric element for the second voltage level.

3. The poling method of claim 2, wherein the second voltage level is higher than the first voltage level.

4. The poling method of claim 1, wherein the voltage performing the preliminary poling is set to be lower than the targeted voltage level.

5. The poling method of claim 1, wherein the piezoelectric element is a plurality of actuators mounted in an inkjet print head.

6. The poling method of claim 5, wherein the targeted piezoelectric characteristic indicates a discharge speed of ink.

7. A poling device for a piezoelectric element, comprising:
a plurality of voltage generation units generating different magnitudes of voltage for poling a plurality of piezoelectric elements;
a plurality of conductance measurement units measuring conductance of the piezoelectric element; and
a control unit storing voltage generated by the voltage generation unit and conductance measured by the conductance measurement unit, respectively, and setting target voltages for performing final poling of the plurality of piezoelectric elements, based on a relational expression between the stored voltage and the conductance of the piezoelectric element, respectively.

8. The poling device of claim 7, wherein the control unit individually sets final poling voltages for the plurality of piezoelectric elements.

9. The poling device of claim 7, wherein the control unit sets the final poling voltages for the plurality of piezoelectric elements simultaneously.

10. An inkjet print head, comprising a plurality of piezoelectric elements for providing driving force to a plurality of pressure chambers,
wherein uniformity (% range) of the plurality of piezoelectric elements is 30% or less, the uniformity (% range) being represented by a percentage (%) after dividing a difference between a maximum displacement and a minimum displacement of the piezoelectric element by an average displacement.
